(19) United States
(12) Patent Application Publication
(10) Pub. No.: US 2025/0272981 A1
(43) Pub. Date: Aug. 28, 2025

(54) SYSTEM FOR MOVEMENT DETECTION AND RELATED METHODS

(71) Applicant: Battelle Energy Alliance, LLC, Idaho Falls, ID (US)

(72) Inventors: Cody M. Walker, Idaho Falls, ID (US); Edna S. Cardenas, Idaho Falls, ID (US); Luis A. Ocampo Giraldo, Idaho Falls, ID (US); Jay D. Hix, Idaho Falls, ID (US); Katherine W. Jesse, Idaho Falls, ID (US); Mitchell R. Greenhalgh, Iona, ID (US); James T. Johnson, Rigby, ID (US)

(21) Appl. No.: 19/042,820

(22) Filed: Jan. 31, 2025

Related U.S. Application Data
(60) Provisional application No. 63/558,444, filed on Feb. 27, 2024.

(51) Int. Cl. G06V 20/52; G06T 7/20; G06V 10/764

(52) U.S. Cl. CPC G06V 20/52; G06T 7/20; G06V 10/764; G06T 2207/10048; G06T 2207/20084

(57) ABSTRACT

A system for detecting leaks includes one or more cameras configured to obtain images of one or more objects to be monitored for leaks and a processor configured to execute machine readable instructions stored on a memory. The system may be configured to receive images from the one or more cameras of the one or more objects to be monitored for leaks; isolate movement in the received images to output isolated movement images; and analyze the isolated movement images to determine whether the isolated movement is a leak, a non-leak, or other movement.

### CROSS-REFERENCE TO RELATED APPLICATION

This application claims the benefit under 35 U.S.C. § 119 (e) of U.S. Provisional Patent Application Ser. No. 63/558,444, filed Feb. 27, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to leak detection. More specifically, this disclosure relates to the monitoring and detection of leaks via optical systems.

### BACKGROUND

Leak detection is utilized across various industries to identify and monitor leaks in pipelines, tanks, and other infrastructure. Leak detection may help prevent environmental contamination, protect assets, and ensure safety by identifying leaks early before such leaks escalate into more significant problems.

Leak detection may be completed via a periodic visual inspection. Such leak detection may suffer from the lack of real time information about a monitored object/system, the failure of an operator to detect an existing leak, or due to the monitored object/system being in an environment that is not easily accessible for a visual inspection.

Some leak detection may be performed by sensors that monitor an object/system for potential leaks. Such sensors may include acoustic sensors, pressure monitoring sensors, flow monitoring sensors, and the like. However, such sensors may suffer from a lack of accuracy such as by providing false indications of a leak when no leak actually exists.

### BRIEF SUMMARY

According to some embodiments, a system for detecting leaks includes one or more cameras configured to obtain images of one or more objects to be monitored for leaks and a processor configured to execute machine readable instructions stored on a memory. When the processor executes the instructions, the system is configured to receive images from the one or more cameras of the one or more objects to be monitored for leaks and isolate movement in the received images to output isolated movement images. The isolated movement images are analyzed to determine whether the isolated movement is a leak, a non-leak, or other movement.

In some embodiments, a method for detecting leaks in one or more monitored objects is provided. The method includes obtaining images of the one or more monitored objects from one or more cameras and isolating movement in the obtained images to generate isolated movement images. The isolated movement images are analyzed to classify the isolated movement as a leak, a non-leak, or other movement. The classification of the isolated movement images is output to detect the presence of a leak.

In some embodiments, a method for detecting leaks in one or more monitored objects is provided. The method includes obtaining a first image of the one or more monitored objects from one or more cameras and obtaining a second image of the one or more monitored objects from the one or more cameras. The second image is obtained at a predetermined time after obtaining the first image. Movement is isolated based on a comparison of the second image to the first image to generate an isolated movement image. The isolated movement image is analyzed to classify the isolated movement as a leak, a non-leak, or other movement.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a detailed understanding of the disclosure, reference should be made to the following detailed description, taken in conjunction with the accompanying drawings, in which like elements have generally been designated with like numerals, and wherein:

FIG. 1 shows an automated leak detection system according to some embodiments;

FIG. 2 shows a method of detecting leaks according to some embodiments;

FIGS. 3A-5B show examples of isolating movement from images according to some embodiments; and

FIG. 6A shows a schematic of an exemplary system on which an automated leak detection system may be implemented, and FIG. 6B shows an exemplary leak detected by an automated leak detection system according to some embodiments.

### DETAILED DESCRIPTION

The illustrations presented herein are not actual views of any leak detection system, leak detection device, or any component thereof, but are merely idealized representations, which are employed to describe embodiments of the disclosure.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any leak detection system, leak detection device, or any component thereof when utilized in a conventional manner. Furthermore, these terms may refer to an orientation of elements of any leak detection system, leak detection device, or any component thereof as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” in reference to a numerical value may include additional numerical values within a range of from 90.0 percent to 108.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

In many applications, a liquid or fluid is held and/or transported through a variety of hardware including various vessels, pipes, valves, and the like. In such applications, a user may wish to monitor such hardware for leaks to ensure that the hardware is working properly and/or to avoid contamination from the liquid leaking into other areas of a system. For example, for chemical separation, a line of contactors may be used to extract a chemical of interest such as uranium or plutonium. Leaks can occur during this process. Such leaks should be identified and located as soon as possible.

According to some embodiments, real-time images or a video from an imaging system (e.g., a camera, such as a high-resolution, infrared camera) may be used to identify leaks. The identification of the leaks may be then supplied to operators of the chemical separation process or other process. Video and/or images from the camera may be separated (e.g., broken up) into frames. Then, movement may be detected between adjacent frames (e.g., the movement of the water droplet formation and release may be detected) such as by using an algorithm referred to as optical flow. Movement over a given time period, such as a 5-second period, may be calculated and condensed to a single image, (e.g., a single frame) that represents the movement in the video/images over the time period. This movement image may then be transmitted (e.g., passed) to a pre-trained image classification model which describes what is contained in the image. The movement image may be classified by the pre-trained image classification model as “no leak,” “leak,” or “other.” The “other” category may be used to describe other sources of movement such as movement of operators, fans, or spurious vibrations. Upon detection of the leak, the operator is notified so that action may be taken. While embodiments described herein may be applicable for detecting leaks for a chemical separation process, they may also be applied in other facilities where leak detection is of importance.

Conventionally, human operators are employed to scan for leaks during operation of a device or process. However, human detection may be inefficient or not possible. Embodiments described herein may allow for sensors (e.g., cameras) and associated image processing to either aid and/or replace humans for this task. According to some embodiments, unidentified or unusual patterns during operation of the device or process may also be identified. The embodiments disclosed herein may be applied in industries that utilize fluid piping for their systems, such as precious materials processing, chemical plants, etc. The embodiments may also be applicable in industries that monitor large tanks or fluid containments. The embodiments disclosed herein may aid in the detection of leaks in places where physical access is limited, undesirable, or impossible, such as in high-radiation areas. Embodiments disclosed herein may further be applicable for industries involved in solvent extraction of any kind (rare earth elements, nuclear, etc.), including industries that deal with leaking materials such as water departments, or ships or submarines monitoring developing leaks.

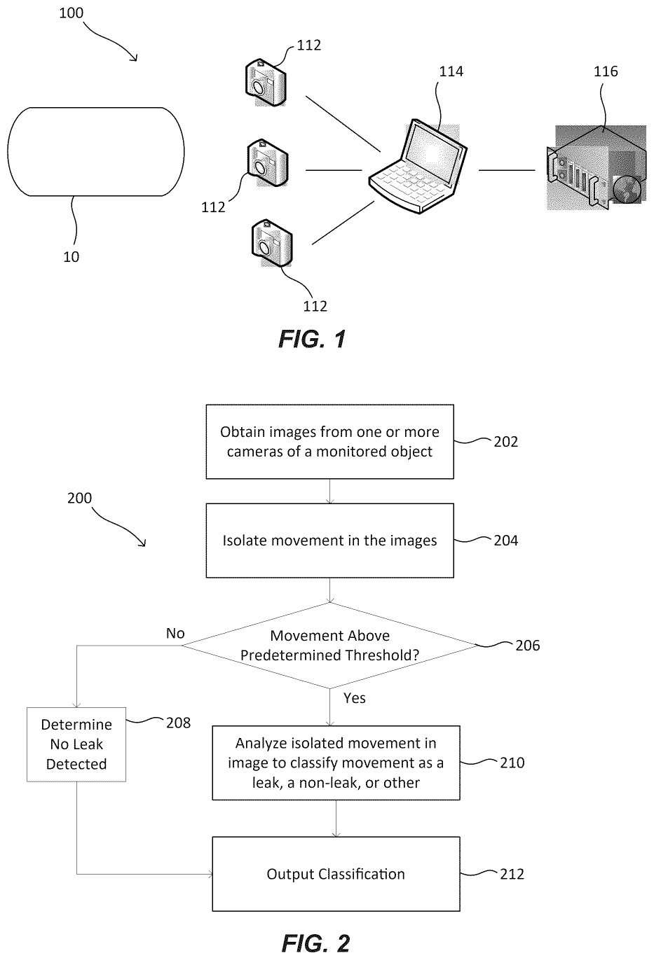

FIG. 1 shows an automated leak detection system according to some embodiments. In FIG. 1, a leak detection system 100 may be configured to observe an object 10 to determine whether leaks are occurring proximal to the object 10. The leak detection system 100 may comprise one or more cameras 112. The one or more cameras 112 may be any suitable camera such as a digital camera comprising an optical system configured to focus light onto an image pickup device, such as a charge-coupled device (CCD) or a complementary metal-oxide-semiconductor (CMOS) device. The one or more cameras 112 may be configured to detect light (e.g., electromagnetic waves) in the infrared spectrum, the visible light spectrum, or any desired spectrum. When the camera 112 is configured to detect light in the infrared spectrum, the camera 112 may be termed an infrared camera. The cameras 112 may be configured to collect images of the monitored object 10 from different angles and/or different distances. The leak detection system 100 is not limited to detecting flow using one or more cameras 112. By way of example only, the leak detection system 100 may include other sensors configured to detect one or more of temperature, vibration, acoustics, pH, and color proximal to the object 10.

The leak detection system 100 may further comprise a computing device 114 that is configured to receive video/images from the one or more cameras 112. The computing device 114 may be any suitable device such as a personal computer, a mobile computing device, such as a mobile phone, or the like. The computing device 114 may comprise one or more memories configured to store image data received from the camera(s) 112. The memories may further be configured to store program instructions (e.g., software) that are executable via one or more processors of the computing device 114. The program instructions may be configured to cause the computing device 114 to perform one or more of the operations described herein.

In some embodiments, the computing device 114 may be connected to a remote server 116 via a network. The remote server 116 may comprise one or more memories and one or more processors similar to the computing device 114. In some embodiments, the computing device 114 may provide image data to the remote server 116, which may perform one or more of the operations described herein.

In some embodiments, the computing device 114 and/or the remote server 116 may comprise artificial intelligence and machine learning algorithms that are utilized to analyze the image data provided by the camera(s) 112 to identify leaks on or around the monitored object 10.

FIG. 2 shows a method of detecting leaks according to some embodiments. As shown in FIG. 2, the method 200 may comprise an act 202 of obtaining images of a monitored object from one or more cameras. For example, referring to FIG. 1, images or videos from the cameras 112 taken of the monitored object 10 may be provided to the computing device 114. In some embodiments, the images or videos may further be provided to the remote server 116. In some embodiments, the images may comprise images taken at a predetermined frequency over a predetermined time period. For example, images may be provided to the computing device 114 or the remote server 116 every second, every 0.5 seconds, every 0.25 seconds, and so forth. In some embodiments, the images may be provided by an infrared camera, a visible light camera, or a camera configured to sense any desired range of electromagnetic waves. In some applications for leak detection for a relatively hot fluid, an infrared camera may be used to provide a clear distinction between the heated fluid and a relatively cooler background. The images may be obtained from multiple different cameras, such as cameras 112, or may be obtained from a single camera.

The method 200 may further comprise an act 204 of isolating movement in the images. For example, the computing device 114 and/or remote server 116 may compare images (e.g., consecutive images) to detect and isolate any movement of items/features proximate to or on the object 10 being monitored in the images. In some examples, an analytical process called optical flow may be used to isolate movement in the images. The analytical process may operate to find movement from one frame/image to the next frame/image. Optical flow may refer to the pattern of apparent motion of items, features, surfaces, and edges in a visual scene caused by the relative motion between an observer and the visual scene. Optical flow may also be defined as the distribution of apparent velocities of movement of brightness pattern in an image. In some embodiments, movement seen in the optical flow caused by shifting the camera (e.g., such as movement of the camera caused by bumping a camera or a mount on which the camera is placed) can be removed by subtracting out the mean movement. An optical flow algorithm may then provide a clear visual of any movement including fluid movement, such as a droplet moving or falling from a target object 10 being observed, while ignoring nonmoving elements. The method may be used to detect even a small volume leak by being able to distinguish between a heated fluid and a relatively cooler background.

The analytical process to isolate movement in the images may compare pixels in a first frame/image taken at a first time to a second frame/image taken at a second time after the first time. Pixels in the second frame/image may be compared to pixels in the first frame/image to determine whether parts of the second frame/image are the same as and whether parts of the second frame/image are different from the first frame/image. Those pixels in the second frame/image that are different from the pixels in the first frame/image may be monitored (e.g., tracked) to determine apparent movement of items/features imaged on or proximate to the object 10 in the first and second frames/images. The movement of the pixels (e.g., a difference in pixel location from the first frame/image to the second frame/image) and the difference in the timestamp of the first and second frames/images may be utilized to determine an apparent velocity of the items/features imaged on or proximate to the object 10 in the first and second frames/images. The computing device 114 or remote server 116 may produce an image showing the moving items/features while removing pixels of the first and second frames/images that are the same (i.e., removing items/features in the first and second frames/images that are not moving). The image produced showing the moving items/features without showing the stationary items/features may be termed an isolated movement image. The isolated movement image may be produced to additionally show an apparent velocity of the moving items/features, such as via coloring the moving items/features according to its apparent velocity (e.g., where some colors represent a relatively slow apparent velocity while other colors represent a relatively faster apparent velocity).

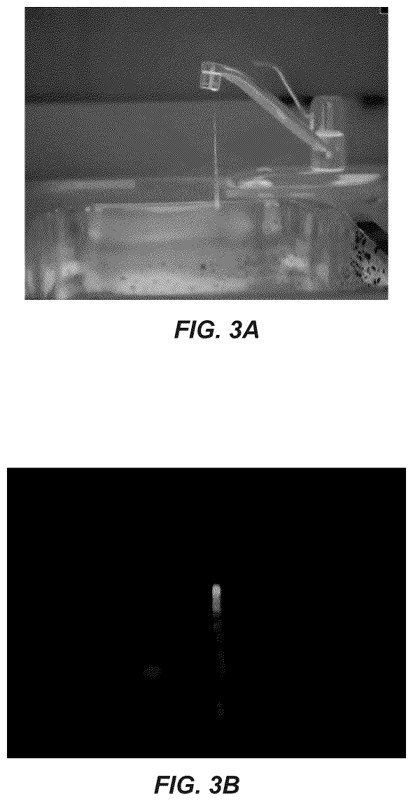

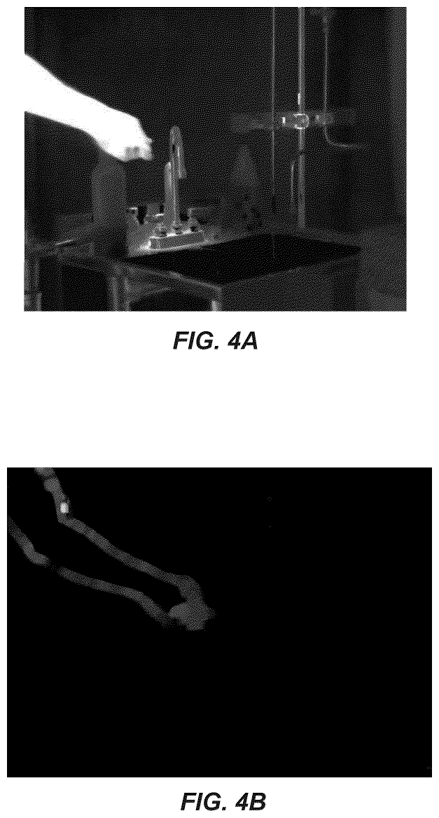

FIGS. 3A-4B show examples of isolating movement from images from the camera. FIG. 3A shows one image of a plurality of infrared images taken by a camera of a leak from a faucet, and FIG. 4A shows one image of a plurality of images of a person moving the faucet with his/her arm and hand. In FIG. 3B, an isolated movement image is created based on the movement of a droplet of fluid leaking from the faucet. In FIG. 4B, an isolated movement image is created based on the movement of the arm and hand of the person.

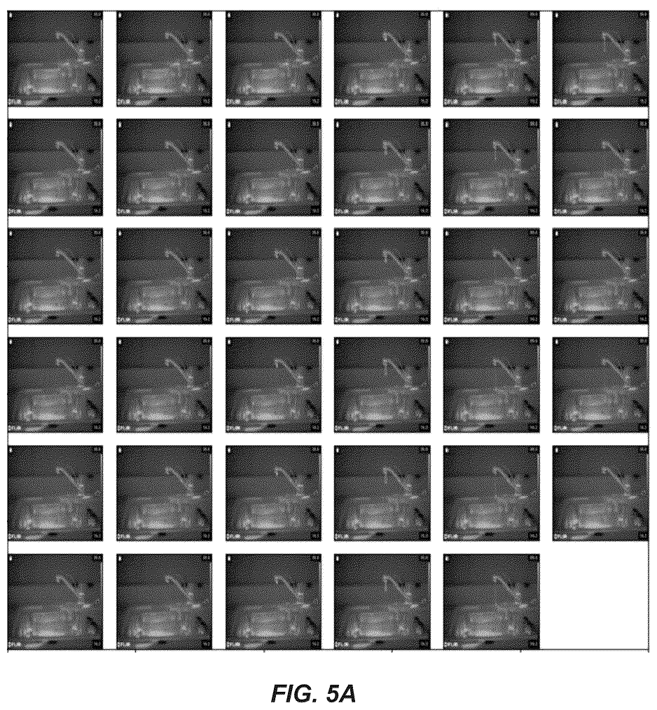

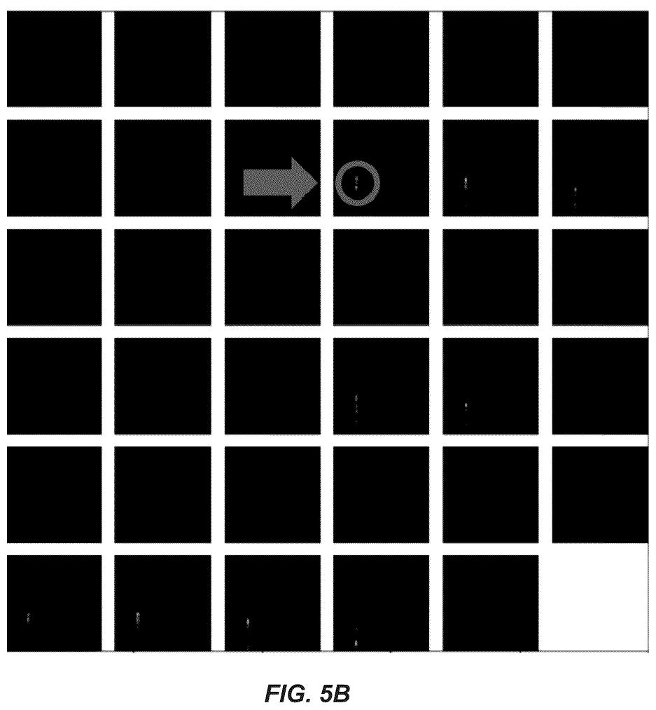

FIGS. 5A and 5B show an additional example of isolating movement from images from the camera of a leak from a faucet. In FIG. 5A, a plurality of images are provided from the camera. The images may be analyzed by the optical flow algorithm to isolate movement by comparing successive images with one another, such as by using optical flow. FIG. 5B shows an example of output isolated movement images where the movement is isolated from the rest of the background in the images. While FIGS. 3A-5B illustrate the movement of water and a person, the movement of other fluids, items, and features may be detected by the leak detection system and methods according to embodiments of the disclosure.

Returning to FIG. 2, in act 206 it is determined whether movement in the isolated movement images is above a predetermined threshold. When no movement is detected in act 206, the method proceeds to act 208, where it is determined that no leak is detected. In act 212, the output may automatically be shown as a “non-leak.” For example, where the isolated movement images show no movement, or movement below a predetermined threshold, the computing device 114 or remote server 116 may be programmed to determine that there is no movement in the isolated movement images, and therefore, that there is no leak.

If there is movement above the predetermined threshold in act 206, then the method proceeds to act 210. In act 210, the output images with the isolated movement (e.g., isolated movement images) are analyzed to classify the movement as a leak, a non-leak, or other classification. The images with the isolated movement may be analyzed via image processing, such as image processing performed on the computing device 114 or remote server 116, to determine whether the movement correlates to a leak, a non-leak, or other action. In some embodiments, the analysis may be completed via artificial intelligence utilizing machine learning which is trained to detect leaks in the images showing the isolated movement. In one example, a convolutional neural network (“CNN”) may be used for image recognition and processing that is trained specifically to identify leaks, such as a leak of fluid from a monitored object 10. In some examples, the CNN may comprise VGG-16 which is a type of CNN to detect and classify objects from images. The VGG-16 may be pretrained to classify the isolated movement images to one of leak, non-leak, or other classification. Other pretrained models may also be used such as Inception V3, EfficientNet, AmcobaNet, Xception, etc.

In some embodiments, a pretrained model may be modified and fined tuned for the method 200 of detecting leaks and the leak detection system 100 described herein. For example, a pretrained image detection system may be fine-tuned using data sets for detecting leaks and other movement expected for a given application of the leak detection system 100. The data sets for detecting and classifying movement from the isolated movement images as leaks may be based on size, velocity, and direction of the moving object in the isolated movement images. For example, a droplet of fluid from a particular source may have a consistent size and may travel with a velocity and direction based on the pull of gravity.

Where movement is detected and isolated, or where movement is above the predetermined threshold, the system may classify the movement as “leak” or “other.” For example, the movement in the isolated movement images may be compared with the pretrained models to identify the type of movement shown in the isolated movement images. The pretrained models may include models for identifying and distinguishing between movement caused by operators moving in an image, movement due to relative motion between the camera (e.g., cameras 112) and the monitored object (e.g., object 10), and movement corresponding to a fluid leak. A plurality of pretrained models may be utilized to analyze and classify the movement detected in the isolated movement images. Each of the plurality of pretrained models may provide a classification, and the classified movement may be based on a majority vote or a plurality vote from the plurality of pretrained models. For example, returning to FIGS. 3A-4B, the system may analyze the isolated movement in FIG. 3B as a “leak,” while the system may analyze the isolated movement in FIG. 4B as “other.”

In act 212, the classification of the movement is output to a user. For example, the output may be displayed on a screen of the computing device 114. In some examples, the output may be provided to the user via a notification to a remote device, such as a push notification on a mobile device, an audio alert provided within a facility, or the like. The output may make the user aware of a leak or movement of an other object and, therefore, allow the user to quickly mitigate the leak or take other appropriate action.

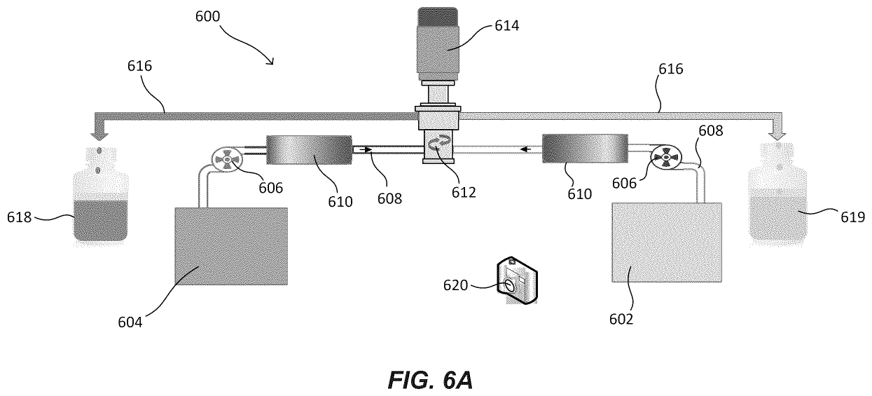

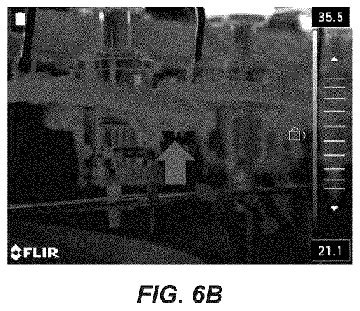

FIG. 6A shows a schematic of an exemplary system on which an automated leak detection system may be implemented, and FIG. 6B shows an exemplary leak detected by an automated leak detection system according to some embodiments. A solvent extraction system 600 may comprise an organic feed tank 602 and an aqueous feed tank 604. The solvent extraction system 600 may be configured to remove one or more materials from an organic material held in the organic feed tank 602.

The solvent extraction system 600 may comprise pumps 606 that move the organic material from the organic feed tank 602 and an aqueous material from the aqueous feed tank through lines 608 (e.g., pipes, tubes, etc.) to heaters 610. Once heated, the aqueous material and organic material may be fed to a centrifuge 612. The centrifuge 612 may be driven by a motor 614. The aqueous material may be configured to attract a desired element or material from the organic material within the centrifuge 612. The aqueous material containing the desired element or material may be output through line 616 and into aqueous tank 618, and the remaining organic material may be fed though a line 616 to an organic tank 619. A controller (not shown) may be provided to control the operation of the pumps 606, heaters 610, centrifuge 612, and motor 614.

Potential leaks may develop within the solvent extraction system 600. For example, leaks may develop in the organic feed tank 602 or aqueous feed tank 604, in the lines 608 or lines 616, in the centrifuge 612, or at connections between the various components of the solvent extraction system 600. Accordingly, the automated leak system (e.g., leak detection system 100) may be used to monitor the solvent extraction system 600 for leaks. To this end, one or more cameras 620 may be provided to monitor the components of the solvent extraction system 600, as mentioned above. FIG. 6B shows an example of a detected leak in an image taken by the camera 620, which may be detected as set forth above. The solvent extraction system 600 is merely one example of a system or application on which the leak detection system may be implemented.

The above-described leak detection system may detect the presence of leaks in the system without the need for visual inspection by an operator. Furthermore, the leak detection system may protect against false positives by classifying detected movement that does not correspond to a leak as an “other” movement instead of reporting such movement as a leak. In this manner, a reliable leak detection system for monitoring an object is provided.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A system for detecting leaks comprising:
one or more cameras configured to obtain images of one or more objects to be monitored for leaks;
a processor configured to execute machine readable instructions stored on a memory, which when executed, cause the system to:
receive images from the one or more cameras of the one or more objects to be monitored for leaks;
isolate movement in the received images to output isolated movement images; and
analyze the isolated movement images to determine whether the isolated movement is a leak, a non-leak, or other movement.

2. The system of claim 1, wherein the isolated movement images are analyzed using a pretrained convolutional neural network.

3. The system of claim 1, wherein the movement is isolated from the received images via an optical flow analysis.

4. The system of claim 1, wherein the one or more cameras comprises an infrared camera.

5. The system of claim 1, wherein the isolated movement is analyzed as the non-leak when the isolated movement is below a predetermined threshold.

6. The system of claim 5, wherein the isolated movement is analyzed as the leak or the other movement when the isolated movement is above the predetermined threshold.

7. A method for detecting leaks in one or more monitored objects, the method comprising:
obtaining images of the one or more monitored objects from one or more cameras;
isolating movement in the obtained images to generate isolated movement images;
analyzing the isolated movement images to classify the isolated movement as a leak, a non-leak, or other movement; and
outputting the classification of the isolated movement images to detect a presence of a leak.

8. The method of claim 7, wherein obtaining images comprises obtaining images from one or more infrared cameras.

9. The method of claim 8, wherein isolating movement in the obtained images comprises detecting differences in temperatures of features within the obtained images.

10. The method of claim 8, wherein analyzing the isolated movement images comprises processing the isolated movement images with pretrained convolutional neural networks.

11. The method of claim 10, wherein analyzing the isolated movement images further comprises receiving an output from each of the pretrained convolutional neural networks with a classification of the isolated movement as the leak, the non-leak, or other, and classifying the isolated movement based on at least a plurality vote of the received outputs.

12. The method of claim 7, wherein isolating movement in the obtained images comprises tracking positions of pixels within the obtained images over successive images.

13. The method of claim 12, wherein tracking positions of the pixels within the obtained images comprises assigning an apparent velocity to the tracked pixels.

14. The method of claim 13, wherein colors in the isolated movement images are generated to correspond to the apparent velocity of the tracked pixels.

15. The method of claim 13, wherein analyzing the isolated movement images comprises comparing the apparent velocity of the tracked pixels to a predetermined threshold velocity, and classifying the isolated movement as the non-leak when the apparent velocity is below the predetermined threshold velocity.

16. A method for detecting leaks in one or more monitored objects, the method comprising:
obtaining a first image of the one or more monitored objects from one or more cameras;
obtaining a second image of the one or more monitored objects from the one or more cameras, the second image being obtained at a predetermined time after obtaining the first image;
isolating movement of items or features in the first and second images based on a comparison of the second image to the first image to generate an isolated movement image; and
analyzing the isolated movement image to classify the isolated movement as a leak, a non-leak, or other movement.

17. The method of claim 16, wherein isolating movement comprises detecting pixels corresponding to the items or features in the first and second images and tracking positions of detected pixels from the first image to the second image.

18. The method of claim 17, wherein tracking positions of pixels comprises assigning an apparent velocity to the tracked position of the detected pixels based on a movement distance of the positions of the detected pixels and the predetermined time.

19. The method of claim 18, wherein colors in the isolated movement image are generated to correspond to the apparent velocity of the detected pixels.

20. The method of claim 18, wherein analyzing the isolated movement image comprises comparing the apparent velocity to a predetermined threshold velocity, classifying the isolated movement as the non-leak when the apparent velocity is below the predetermined threshold velocity, and processing the isolated movement image with a pretrained convolutional neural network to classify the isolated movement as the leak or the other movement when the apparent velocity is above the predetermined threshold velocity.
